(19) United States
(12) Patent Application Publication
(10) Pub. No.: US 2003/0136021 A1
(43) Pub. Date: Jul. 24, 2003

(54) Dry-ball

(76) Inventor: Arronn Lee Pesnell, Arlington, TX (US)

Correspondence Address: Arronn Lee Pesnell, 3022 Franciscan Drive, #1138, Arlington, TX, 76015, US

(21) Appl. No.: 10/050,821

(22) Filed: Jan. 18, 2002

(51) Int. Cl. F26B 11/02; D06F 58/00

(52) U.S. Cl. 34/595; 34/132; 34/108

(57) ABSTRACT

The present invention is a portable cart for maintaining athletic balls in a warm and dry condition, comprising an insulated container having an interior drum configured to hold up to twelve (12) footballs, or other sports balls such as, soccer balls, rugby balls, baseballs, etc. A handle and wheels are secured to the container to facilitate easy transporting of the unit around the playing field. The balls are secured to a circular drum that rotates the balls through a heating and drying cycle. The unit contains an air filter, a heating element, a blower fan, a back-up battery, and a thermostat to control temperature. As wet, cold balls are placed onto the drum within the unit, they pass through the heating and drying cycle, eventually rotating back to the front door, having been effectively heated to the desired temperature and dried, readying them for play.

### CROSS-REFERENCE TO RELATED APPLICATION

Several references reveal various athletic ball heating and drying devices. For example:

U.S. Pat. No. 4,055,002 to Roberts discloses a portable dryer for wiping and drying wet footballs;

U.S. Pat. No. 5,137,011 to Roth, discloses a golf ball heating device for use during a round of golf;

U.S. Pat. No. 4,140,893 to Renteria discloses a ball warming apparatus adapted to heat a cold bowling ball;

U.S. Pat. No. 4,026,310 to Beauregard discloses a drying box for footballs;

U.S. Pat. No. 4,137,040 to Starkey discloses a football drier; and

U.S. Pat. Application No. 20010037583 to Stuckey discloses a ball dryer and dehydrator.

While the units mentioned above may be suitable for the particular purpose employed, or for general use, they would not be as suitable for the purposes of the present invention as will be disclosed below.

### STATEMENT REGARDING FEDERAL SPONSORED RESEARCH OR DEVELOPMENT

Not Applicable

### REFERENCE TO A MICROHICHE APPENDIX

Not Applicable

### BACKGROUND OF THE INVENTION

This invention is related to the field of sports and athletic equipment and is a portable cart for maintaining athletic balls in a warm and dry condition. More particularly, the invention is a portable cart that contains a heating element, an electric blower, and a drum designed to hold up to twelve (12) footballs simultaneously and is used to heat and dry wet and cold balls placed into it.

Outdoor sports such as football, soccer, and baseball are sometimes played under severe weather conditions. Less than ideal weather has a direct, negative effect on the condition of the athletic balls and players' performance. For example, during extremely cold weather, balls tend to harden, making them uncomfortable and difficult to handle, affecting the user's ability to control the ball. Particularly in wet field conditions, the moisture from rain or snow, combined with cold outdoor temperatures, will cause balls to become slippery, making them much more difficult to handle. Therefore, this invention is a dynamic innovation in sports equipment, enabling teams and players to have a larger number of heated and dry balls available during athletic events. This invention is a less complicated alternative to the prior art and yields a larger number of warm, dry footballs.

### BRIEF SUMMARY OF THE INVENTION

It is an object of the invention to provide a portable cart capable of effectively heating and drying cold and wet athletic balls during sporting events, thereby enhancing and optimizing player performance.

It is another object of the invention to provide a portable cart equipped with a circular drum inside that will hold up to twelve (12) footballs at a time. As the circular drum rotates, it advances the balls through the cycle, effectively heating and drying the balls. When a ball has rotated 360° it is fully heated and dried, ready for play.

The invention is totally electric and can be connected to a power source or run directly from it's internal battery. It is also equipped with a heating element; a thermostat controlled by micro switches; a filtering system; and blower fan to circulate hot, dry air within the unit. A handle and wheels are secured to the exterior of the unit to facilitate easy transportation across the surface of the playing field. To accomplish these objectives, the invention may be embodied in a form illustrated in the accompanying drawings. Attention is called to the fact, however, that the drawings are illustrative only. Variations of the invention are contemplated.

### BRIEF DESCRIPTION OF THE SEVERAL VIEWS OF THE DRAWING

FIG. 1—FIG. 1 represents a view from the side of the unit showing the internal operation of the drum holding up to twelve (12) footballs at a time, the filter, the heater coils, the blower fan, and the battery.

FIG. 2—FIG. 2 represents a view from the top of the unit.

FIG. 3—FIG. 3 represents a view from the front end of the unit showing the door that allows balls to be placed into the unit and removed when dry.

### DETAILED DESCRIPTION OF THE INVENTION

The invention is a sports equipment device used to heat and dry athletic balls for use during sporting events that enhances and optimizes player performance on the field. Wet and/or cold balls are placed into the unit through a door that opens at the front of the cart. There is room for up to twelve (12) footballs at one time. The unit can be adapted to accommodate soccer balls, rugby balls, baseballs, etc. As the balls are placed into the unit, the drum that they are attached to rotates toward the back allowing a fresh, warm and dry ball to come into the door opening. As the balls rotate around the drum the unit circulates hot, dry air throughout the inside of the cart, effectively heating and drying the balls.

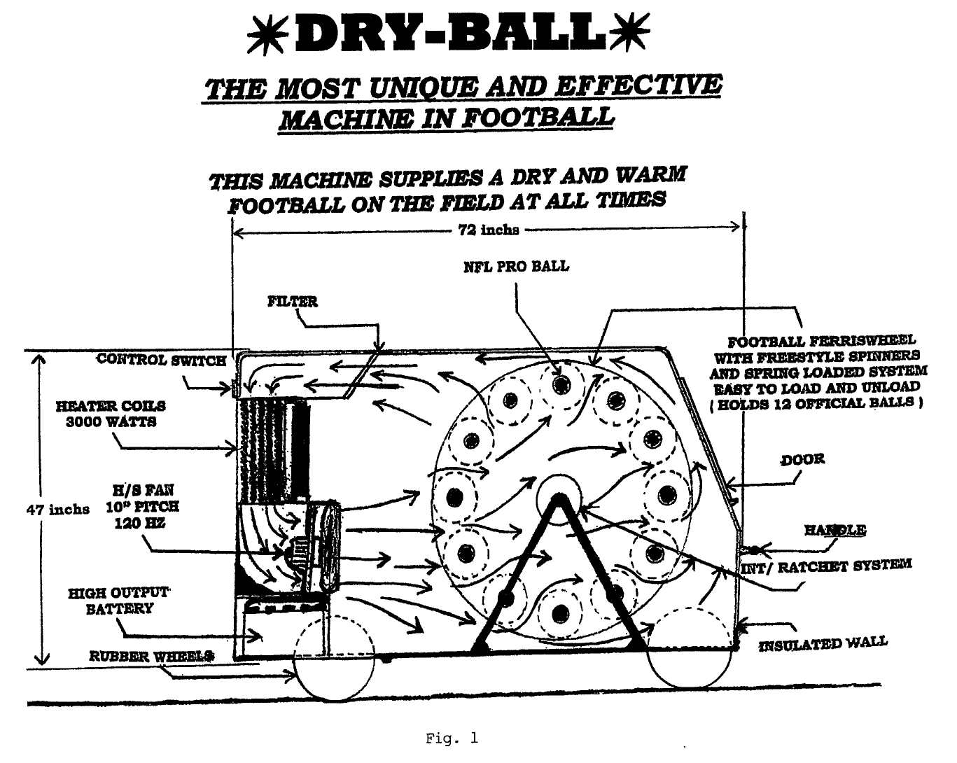

FIG. 1 of the drawings shows the invention from the left side of the unit with the door opening at the right. As a ball is placed inside the door opening, it is secured to the drum between two (2) spring-loaded cups that grip the ball. The unit can hold up to twelve (12) balls at a time. The drum rotates toward the back of the unit eventually bringing it back to the door opening where it is ready for use. The blower fan circulates the heated air around the balls, drying and warming them.

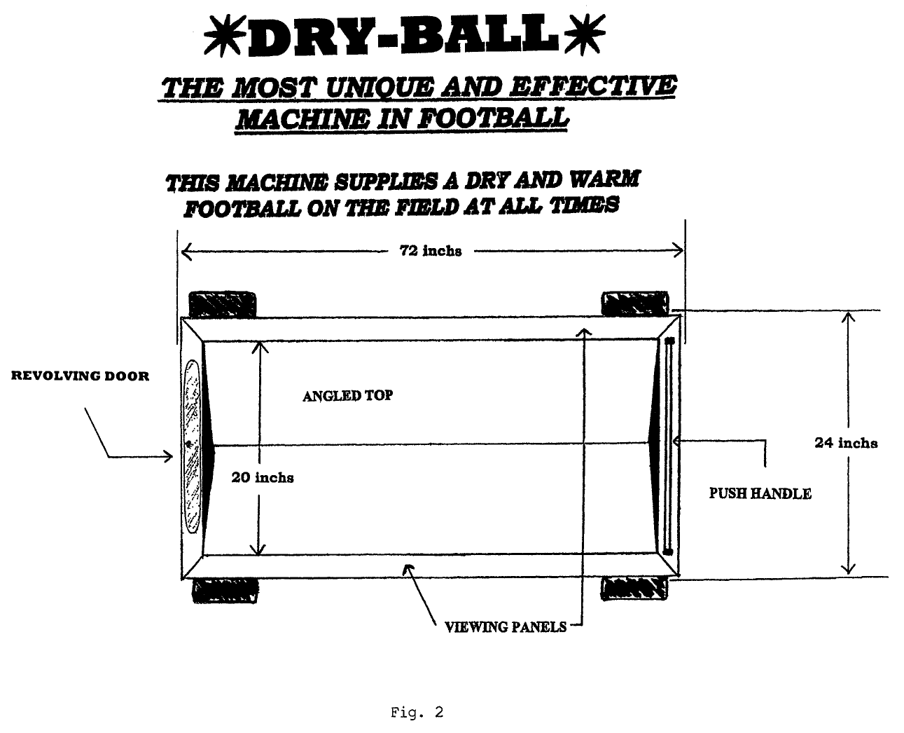

FIG. 2 of the drawings shows the invention from the top of the unit with the door opening on the left. The top of the unit is slightly smaller than the bottom. It has four (4) wheels attached at the comers allowing easy mobility.

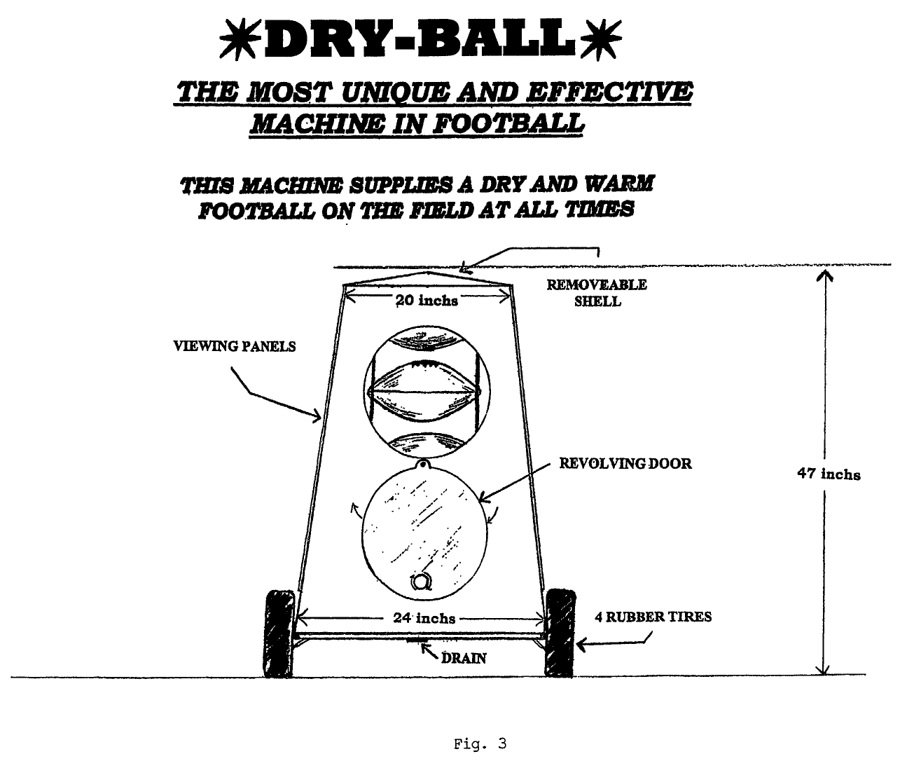

FIG. 3 of the drawings shows the invention from the front end showing the front door of the unit. The outer shell of the unit is removable to allow for maintenance as needed. The unit is 24 inches wide at the bottom, 20 inches wide at the top, 47 inches high and 72 inches long.

While the details of this discussion are presented with respect to footballs, it is also adaptable to other types of balls, including soccer balls, rugby balls, baseballs, etc. This should not be construed as a limitation on the scope of the invention, as many other variations are possible.

1. What I claim as my invention is a less complicated type of sports equipment comprised of a large drum, capable of holding up to twelve (12) cold and/or wet athletic balls, a heating element, a blower fan, an air filter, and a battery, all housed within a lightweight container. As the balls travel around the drum, they are heated and dried, enhancing the ease and comfort of their use during athletic events held outdoors in severe or adverse weather conditions. This unit will change the performance levels and effectiveness of the athletes involved. This marks a significant advancement and simplification over prior art or the use of plastic or nylon bags that are merely containers to hold wet, cold balls and do nothing to improve player performance.
